(19) United States
(12) Patent Application Publication
(10) Pub. No.: US 2009/0106120 A1
(43) Pub. Date: Apr. 23, 2009

(54) Apparatus and system to market products via internet

(76) Inventor: Michael A. Canfield, Phoenix, AZ (US)

Correspondence Address: TOD R NISSLE, PO BOX 55630, PHOENIX, AZ, 85078, US

(21) Appl. No.: 12/231,677

(22) Filed: Sep. 4, 2008

Related U.S. Application Data
(60) Provisional application No. 60/967,373, filed on Sep. 4, 2007.

(51) Int. Cl. G06Q 30/00

(52) U.S. Cl. 705/26

(57) ABSTRACT

A system to market products via the Internet pays an Internet surfer to view and evaluate offers for sale on the Internet.

This application claims priority based on U.S. Provisional Patent Application Ser. No. 60/967,373 filed Sep. 4, 2007.

### OVERVIEW

JITLA is a new system to market products on the Internet.

JITLA includes a proprietor and JITLA members. JITLA members comprise merchants and customers that join JITLA. There is no charge to join JITLA. The proprietor operates the JITLA system including a web site and server, and receives revenue produced by JITLA.

### Functions of JITLA

JITLA
reduces the cost of advertising,
provides a merchant with demographic information about a customer,
pays a potential customer a nominal amount to review a merchant's offer for sale
   provides a merchant with the likelihood that a customer will purchase
      the merchant's product
   minimizes or eliminates click fraud
   minimizes or eliminates e-mail spam
   reduces the time required for a customer to find and purchase a product
   facilitates the introduction of a customer to a merchant selling the product the customer desires
   provides a merchant with feedback concerning the effectiveness of the
      merchant's advertising

### Revenue Streams

Potential revenue streams can be produced for the JITLA proprietor.

One revenue stream comprises a payment made by a merchant to the proprietor when a targeted message from a merchant is sent to a surfer concerning a product sought after by the surfer customer.

A second revenue stream comprises a payment made by a merchant to the proprietor when an e-mail from a merchant is sent to a customer concerning a product sought after by the customer.

A third revenue stream comprises a payment made by a merchant to the proprietor when a customer reviews and answers questions by the merchant at the merchant's web site.

A fourth revenue stream comprises a payment made by a merchant to the proprietor when a customer buys the merchant's product.

### Use of JITLA

In use of the system, a customer inputs demographic information, information concerning a product that customer wishes to purchase, the amount the customer wishes to pay, any discount desired by the customer, and inputs an “Ad Bid”, say for example $2.00, that comprises the amount the customer wishes to be paid to look at a merchant's offer to buy. The JITLA server stores this information in a format deemed a “Calling Card”, and sends the “Calling Card” to merchants that sell the product desired by the customer and that meet criteria set forth by the customer. The server prioritizes “Calling Cards” so that merchants receive “Calling Cards” such that the customer with the lowest “Ad Bid” is listed first. Each “Calling Card” received by a merchant also includes an evaluation of the likelihood that a customer will purchase a product from the merchant.

When a merchant receives calling card, the merchant selects one or more customers. After the merchant selects one or more customers, JITLA has three operational modes.

### The E-Mail Mode

The first operational mode is the e-mail mode. The merchant e-mails the customers an invitation to review an offer at the merchant's web site. If the customer accepts such an invitation and clicks on a link to the merchant's web site, then after the customer reviews the web site, the merchant pays the proprietor a nominal amount and pays the customer the Ad Bid price offered by the merchant. The customer review is simple and consists of the customer clicking on a number in a 1 to 10 to evaluate the merchant's advertising. The merchant is provided with customer reviews of its advertising.

The customer's e-mail only accepts e-mails from qualified merchants and from individuals listed on the customer's e-mail list. This procedure limits spam.

If after reviewing the merchant's offer, the customer buys a product from the merchant, the merchant pays a nominal fee to the proprietor.

The web site of the merchant can include a Q & A system. If a customer answers questions in the Q & A system, the merchant pays the proprietor a nominal amount and pays the customer a nominal amount for each question answered.

### The Surfing Mode

The second operational mode is the surfing mode. If the customer is on the Internet, invitations from a merchant can appear on the customer's computer screen. If the customer accepts an invitation and clicks on a link to the merchant's web site, then after the customer reviews the merchant's web site, the merchant pays the proprietor a nominal amount and pays the customer the Ad Bid price offered by the merchant.

If after reviewing the merchant's offer, the customer buys a product from the merchant, the merchant pays a nominal fee to the proprietor.

### The Directory Mode

The third operational mode is portal access called the Mall mode. If a customer is at the proprietor's mall web portal site and selects a specific merchant's invitation and clicks on a link to the merchant's web site, then after the customer reviews the merchant's web site, the merchant pays the proprietor a nominal amount and pays the customer the Ad Bid price offered by the merchant.

An example of a JITLA system is described below in conjunction with the drawings, in which:

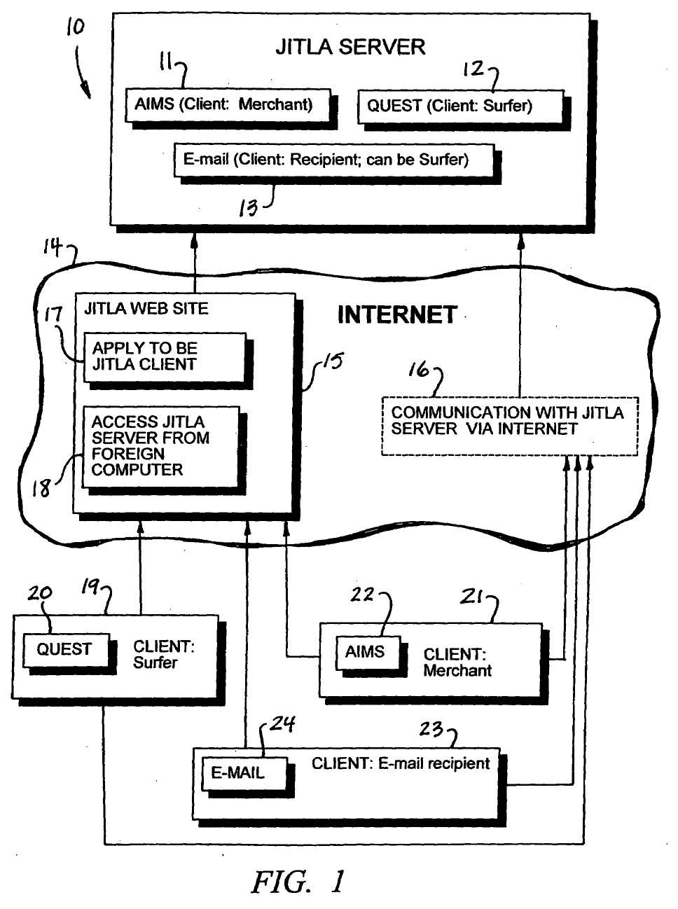

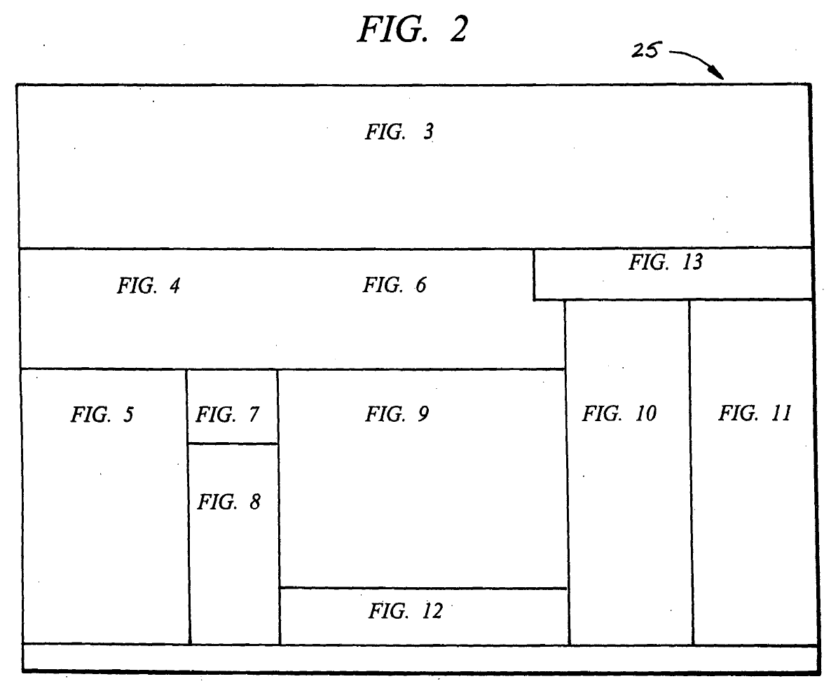

FIG. 1 is a schematic illustrating the functioning of a JITLA server in conjunction with the Internet;

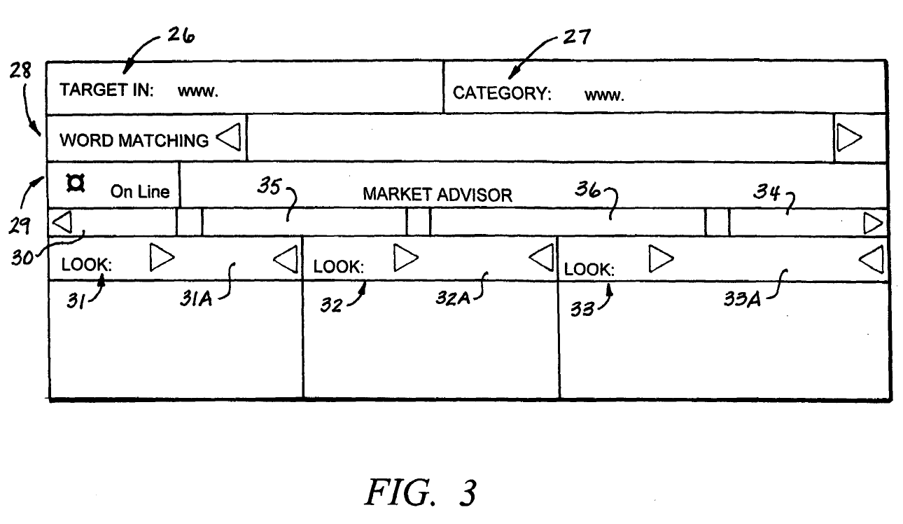

FIG. 2 is a template illustrating the appearance of an AIMS screen dashboard display that appears on the computer screen of a JITLA merchant wherein each portion of the merchant's computer screen display is illustrated in one of FIGS. 3 to 13 noted in FIG. 2;

FIG. 3 illustrates a portion of the AIMS screen of FIG. 2;

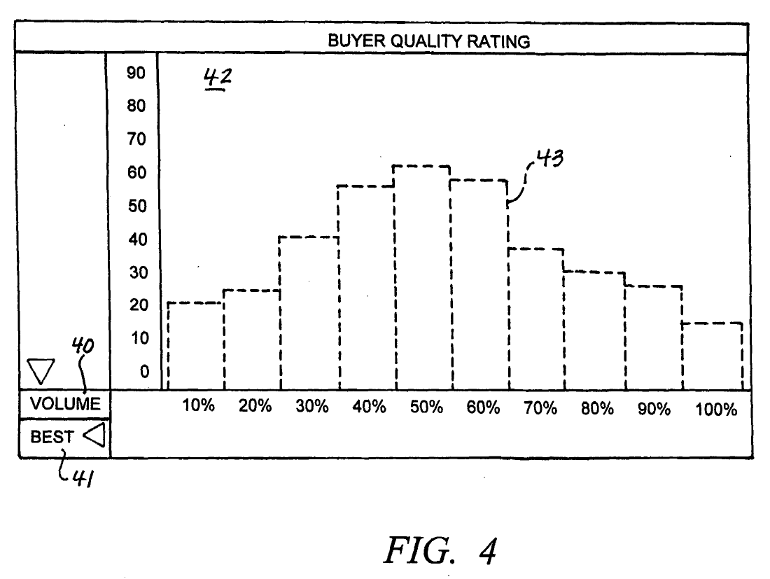

FIG. 4 illustrates another portion of the AIMS screen of FIG. 2;

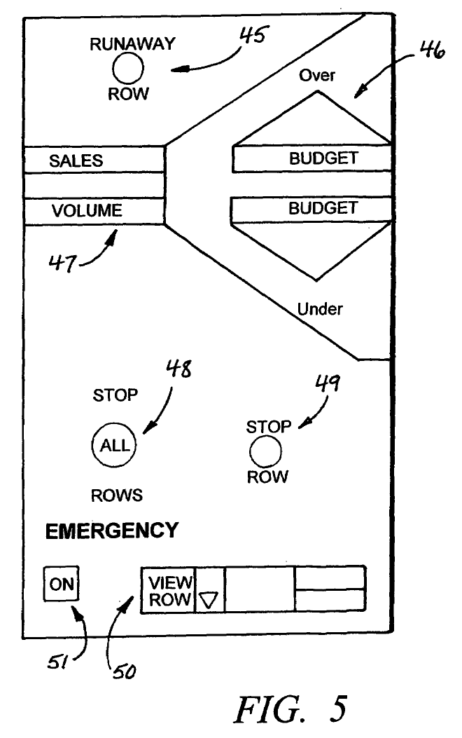

FIG. 5 illustrates a further portion of the AIMS screen of FIG. 2;

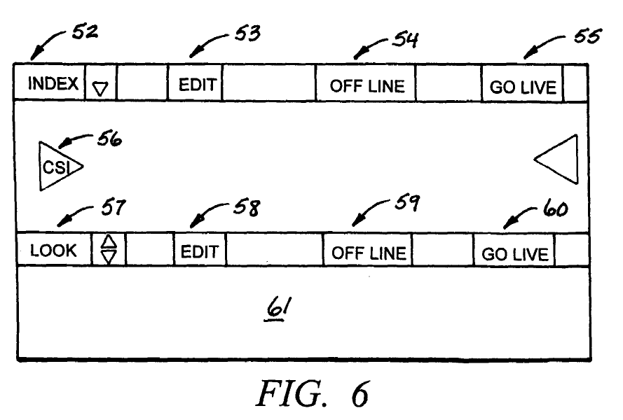

FIG. 6 illustrates yet another portion of the AIMS screen of FIG. 2;

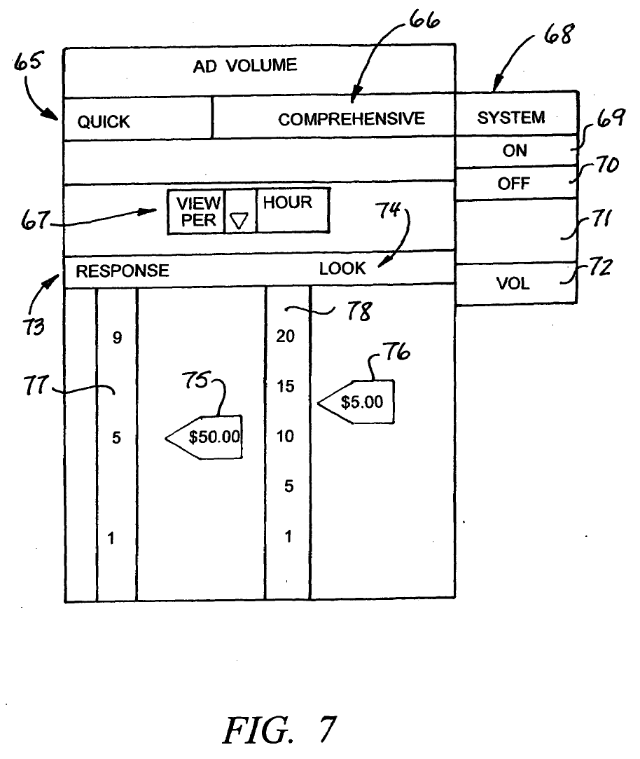

FIG. 7 illustrates yet a further portion of the AIMS screen of FIG. 2;

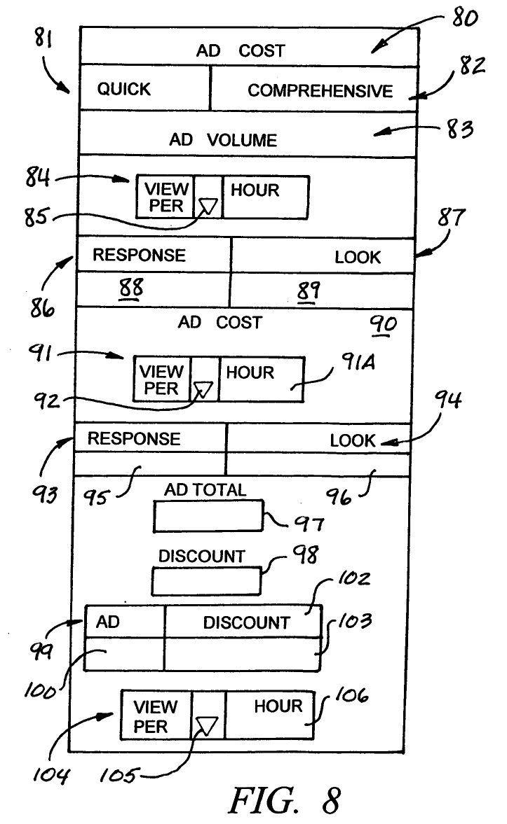

FIG. 8 illustrates still another portion of the AIMS screen of FIG. 2;

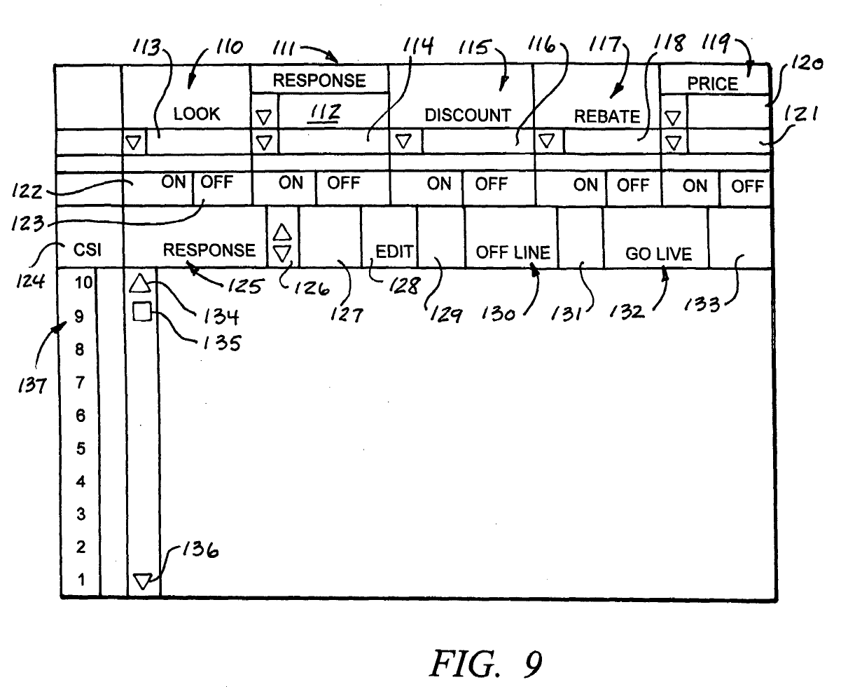

FIG. 9 illustrates still a further portion of the AIMS screen of FIG. 2;

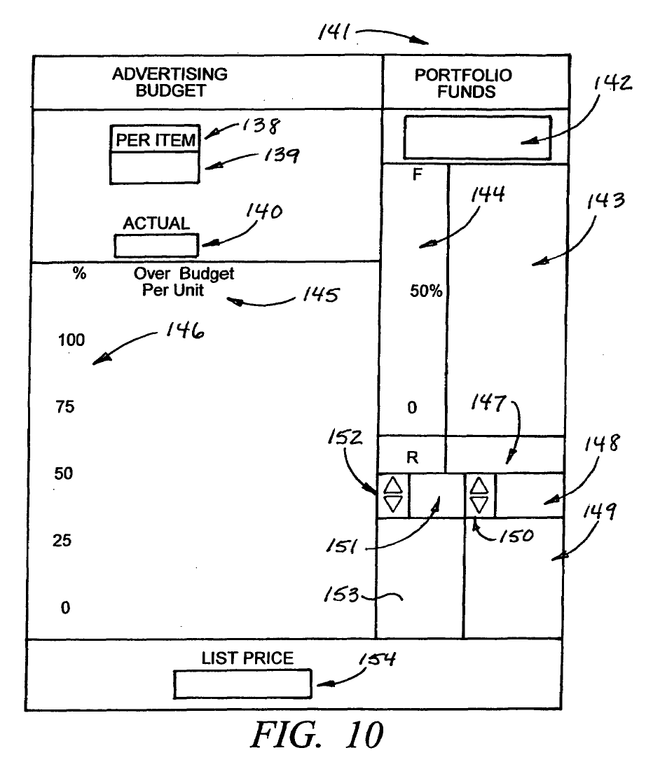

FIG. 10 illustrates yet still another portion of the AIMS screen of FIG. 2;

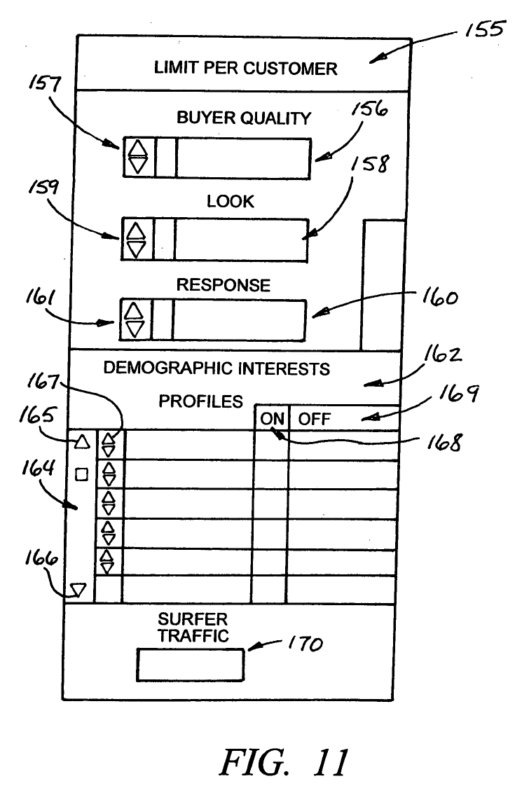

FIG. 11 illustrates yet still a further portion of the AIMS screen of FIG. 2;

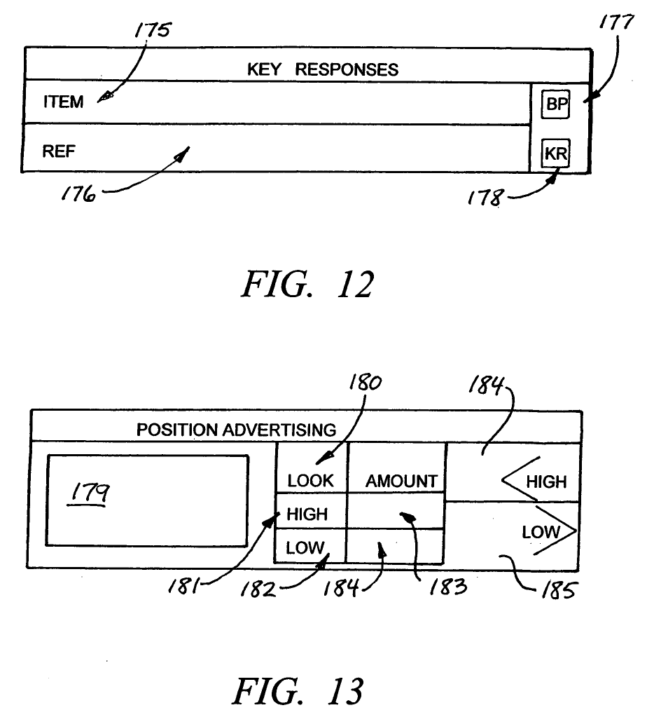

FIG. 12 illustrates another portion of the AIMS screen of FIG. 2;

FIG. 13 illustrates a further portion of the AIMS screen of FIG. 2; and,

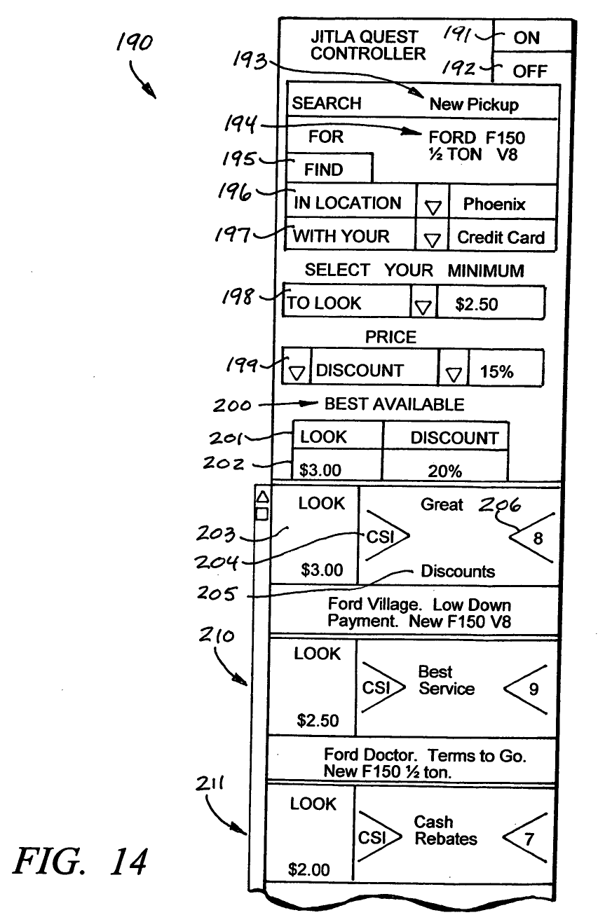

FIG. 14 illustrates the JITLA Quest Controller.

Briefly, in accordance with the invention, I provide an improved system to market products in an Internet network. The system includes a computer server (10); a surfer computer (19); a surfer account; a merchant computer (21); a merchant account; and, a merchant web site. The server (10) pays the surfer account a selected amount from the merchant account when the merchant web site is accessed by the surfer computer via the Internet network.

In FIG. 1 a JITLA computer server 10 includes an AIMS subroutine 11 that, along with memory, comprises a program for merchants participating in JITLA. Server 10 also includes a QUEST subroutine 12 that, along with a memory, comprises a program for surfers (individuals) participating in JITLA. Server 10 also includes an e-mail sub-routine 13 that, along with a memory, comprises a program for e-mail for surfers or other recipients.

A surfer 19 has a computer with a QUEST computer program 20 that communicates with the JITLA web site 15 on the Internet 14 or that communicates 16 with the JITLA server 10 via the Internet 14. A merchant 21 has a computer with an AIMS computer program 22 that communicates with the JITLA web site 15 on the Internet 14, or that communicates 16 with the JITLA server 10 via the Internet 14. An e-mail recipient has a computer with an e-mail program 24 that communicates with the JITLA web site 15 on the Internet 14, or that communicates with the JITLA server 10 via the Internet 14.

FIG. 2 is a template illustrating the appearance of an AIMS screen dashboard display 25 that appears on the computer screen of a JITLA merchant 21. Each portion of the merchant's computer screen display is illustrated in one of FIGS. 3 to 13 noted in FIG. 2.

The portion of the AIMS computer screen dashboard display 25 illustrated in FIG. 3 includes target in 26, category 27, word matching 28, display space 37, on line 29, and a market advisor. The market advisor includes spaces 30, 35, 36, 34, as well as “LOOK” 31 with display space 31A, “LOOK” 32 with display space 32A, and “LOOK” 33 with display 33A.

The portion of the AIMS computer screen dashboard display 25 illustrated in FIG. 4 comprises a buyer quality rating with an a graphical representation 42 indicated by dashed lines 43, vertical axis with values 0 to 90, and horizontal axis with percentage increments from 10% to 100%. In the lower left corner of the buyer quality rating is a “VIEW ROW” box 50.

The portion of the AIMS computer screen dashboard display 25 illustrated in FIG. 5 comprises a “RUNAWAY ROW” button 42 (that is activated with a click of the button), a “STOP ALL ROWS” button 48, a “STOP ROW” button 49, an “ON” button, a “SALES—VOLUME” area 47, an “OVER-UNDER BUDGET” area 46, and a “VIEW ROW” box 50.

The portion of the AIMS computer screen dashboard display 25 illustrated in FIG. 6 includes “INDEX” 52, “EDIT” 53, “OFF LINE 54”, “GO LIVE” 55, “CSI” 56, “LOOK” 57, “EDIT “58”, “OFF LINE” 59, “GO LIVE” 60, and display space 61.

The portion of the AIMS computer screen dashboard display 25 illustrated in FIG. 7 includes an “AD VOLUME” monitor including “QUICK” 65, “COMPREHENSIVE” 66, “VIEW PER” box 67, “RESPONSE” 73 with vertical axis values 1 to 9 and indicator 75, “LOOK” 74 with vertical axis values 1 to 20 and indicator 76, “SYSTEM” 68 with “ON” 69, “OFF” 70, display space 71, and “VOL” 72.

The portion of the AIMS computer screen dashboard display 25 illustrated in FIG. 8 includes “AD COST” heading 80, “QUICK” heading 81, “COMPREHENSIVE” heading 82, “AD VOLUME” heading 83, “VIEW PER” box 84 with button 85 and “HOUR” display, “RESPONSE” heading 86 with associated display space 88 underneath, “LOOK” heading 87 with associated display space 89 beneath, “VIEW PER” box 91 with button 92 and “HOUR” display 91A, “RESPONSE” heading 93 with associated display space 95 underneath, “LOOK” heading 94 with associated display space 96 underneath, “AD TOTAL” display box 97, “DISCOUNT” display box 98, “AD” heading 99 with associated display space 100 underneath, “DISCOUNT” heading 102 with associated display space 103 underneath, “VIEW PER” box 104 with button 105 and “HOUR” display box 106.

The portion of the AIMS computer screen dashboard display 25 illustrated in FIG. 9 includes “LOOK” 110, “RESPONSE” heading 111 with associated display box 114, “DISCOUNT” heading 115 with associated display box 116, “REBATE” heading 117 with associated display box 118, “PRICE” heading 119 with associated display boxes 120 and 121, “ON” heading 122, “OFF” heading 123, “CSI” (customer satisfaction index) heading 124 above a CSI scale 1, 2, 3, 4, 5, to 10, indicator 135 operatively associated with the CSI scale to indicate the CSI, triangular buttons 134 and 136, “RESPONSE” heading 125 with associated triangular up and down buttons 126 and associated display box 127, “EDIT” heading 128 with associated display box 129, “OFF LINE” heading 130 with associated display box 131, and “GO LIVE” heading 132 with associated display box 133.

The portion of the AIMS computer screen dashboard display 25 illustrated in FIG. 10 includes the “ADVERTISING BUDGET” heading, “PER ITEM” heading 138 with associated display box 139, “ACTUAL” heading with the associated display box 140, the “% Over Budget Per Unit” heading 145 over vertical percent scale “0, 25, 50, 75, 100” 146, “PORTFOLIO FUNDS” heading 141 over display box 142 and over vertical scale “0, 50%, 0” 144 and over associated display box 143, heading “R” over associated up and down buttons 152 and associated display boxes 151 and 153, display box 147, display boxes 148 and 149 and associated up and down buttons 150, and heading “LIST PRICE” and associated display box 154.

The portion of the AIMS computer screen dashboard display 25 illustrated in FIG. 11 includes “BUYER QUALITY” heading and associated up and down buttons 157 and display box 156, “LOOK” heading and associated up and down buttons 159 and display box 158, “RESPONSE” heading and associated up and down buttons 161 and display box 160, “DEMOGRAPHIC INTEREST/PROFILES” heading 162 and associated table in which desired demographic profile data (i.e., age, location, interests, hobbies, etc.) desired by a merchant can be entered and selected by a merchant by clicking on triangular on and off buttons 167, on and off buttons 165 and 166 to click on to move square 164 up or down as desired to select a particular demographic in the table, “ON” heading 168 (a box below said heading being checked to indicate when the demographic quality associated with the box is desired by the merchant), “OFF” heading 169 (a box below said heading being check to indicate when the demographic quality associated with the box is not desired by the merchant), and “SURFER TRAFFIC” heading associated with display box 170.

The portion of the AIMS computer screen dashboard display 25 illustrated in FIG. 12 includes “KEY RESPONSES” heading, “ITEM” heading in associated box 175, “REF” heading in associated display box 176, “BP” button 177, and “KR” button 178.

The portion of the AIMS computer screen dashboard display 25 illustrated in FIG. 13 includes “POSITION ADVERTISING” heading associated with display box 179, “LOOK” heading 180, “HIGH” heading 181 associated with display box 183, “LOW” heading 182 associated with display box 184, “HIGH” heading in and associated with display box 184, and “LOW” heading in and associated with display box 185.

FIG. 14 illustrates the JITLA QUEST CONTROLLER display that appears on the computer of a surfer that is a member of JITLA and includes “ON” heading 191; “OFF” heading 192; “SEARCH FOR” heading associated with a display area that shows product information input and desired by a surfer (which product information in FIG. 14 includes, by way of example, “New Pickup” and “FORD F150 ½ TON V8” entered by a surfer using the JITLA QUEST CONTROLLER); “FIND” heading 195; “IN LOCATION” heading 196 associated with a triangular button and a display box in which “Phoenix” has been entered by a surfer using the JITLA QUEST CONTROLLER to indicate the desired location; “WITH YOUR” heading 197 associated with triangular button and a display box in which “Credit Card” has been entered by a surfer using the JITLA QUEST CONTROLLER to indicate how a purchase would be paid for; “SELECT YOUR MINIMUM” heading with associated box 198 including the “TO LOOK” heading 198, a triangular button, and a display box in which a surfer (customer) using the QUEST CONTROLLER has entered “$2.50” as the minimum amount that the surfer wishes to be paid to look at a merchant web site selling a product desired by the surfer; “PRICE” heading with associated box 199 including a first left hand triangular button, “DISCOUNT” heading, a second triangular button to the right of the “DISCOUNT” heading, and display box in which a surfer using the QUEST CONTROLLER has entered “15%” to indicate the minimum desired discount on the product price; “BEST AVAILABLE” heading 200 with the associated display box including headings “LOOK” and “DISCOUNT” 200 and their associated display boxes 202 in which “$3.00” and “20%” appear to indicate to a surfer that the best “LOOK” price being offered by a JITLA merchant is $3.00 and the best “DISCOUNT” being offered by a JITLA merchant is 20%. List and appearing below said display box are a series of merchant “LOOK” offers that have (based upon (1) demographic information provided by the surfer, (2) minimum “LOOK” 198 and “DISCOUNT” 199 values entered by the surfer, (3) product information entered by the surfer, and (4) surfer demographic information that is required by a merchant and that is provided and met by the surfer) been located by the JITLA sever 10.

The first look offer or “banner” is the best offer for the surfer and includes display box 203 with “LOOK” heading and the amount “$3.00” being offered by a JITLA merchant for a surfer to look at a merchant web page offering a FORD F150 pickup truck for sale; includes a display box 204 that indicates to a surfer that the merchant has a CSI rating of 8 (on a scale of one to 10) 206 and indicating sales pitch information 205 offered by the merchant and comprising the words “Great Discounts”; and, includes further merchant information including “Ford Village. Low Down Payment. New F150V8”.

The second look offer or “banner” 210 is the next best offer for the surfer and similarly includes a “LOOK” amount of $2.50 offered by a merchant, a CSI rating of 9, and additional information “Best Service” and “Ford Doctor. Terms to Go. New F150 ½ ton”.

And the third look offer or “banner” 211 listed is the next best offer for the surfer.

When a surfer selects (i.e., clicks on) one of the look offers or banners provided by the JITLA QUEST CONTROLLER, the JITLA server 10 takes the surfer to the merchant's web site in an on-line “mall” comprising web pages offering products for sale by JITLA member merchants. The surfer reviews the web site and, before the surfer leaves the web site, the surfer must click on a number in a “one to ten” scale to evaluate and grade the look offer or “banner” that was initially provided by the merchant. Such grades are continuously monitored by the JITLA server and averaged to provide a CSI grade for the merchant. This CSI grade is what appears 206 in a look offer or banner of the type illustrated in FIG. 14 and is used by a surfer in determining whether to go to the merchant's web site. The CSI “grade” indicates whether the surfer though the banner was accurate, was a good offer, etc. The requirement that a JITLA surfer grade a banner before the surfer leaves a merchant's site is called “grade n go”. The grade n go system is an integral part of the JITLA system. In addition to surfing for a particular product, a JITLA customer can also, after entering product and demographic information, receive and e-mail from a merchant, which e-mail can contain look offers that will, if accepted by the e-mail recipient, take the e-mail recipient to one of the merchant's web sites. Each product offered for sale by a merchant at the JITLA on-line mall has its own web site.

When a merchant joins JITLA, the first thing he does is to utilize the AIMS dashboard 25 to enter product and service data input web pages (i.e., files) or information that is incorporated in JITLA web pages. In these files, the merchant can includes video, words, text to describe a product. In many cases, only text and picture, or, just text will be utilized and video will not be utilized. The web pages or files input by the JITLA merchant are indexed by the JITLA server 10 so they can be brought up on request by the merchant and applied by merchant to the merchant's web page(s) so that can be seen or accessed by a surfer or recipient. As noted, each particular product has its own web page. In other words, the merchant builds a portfolio of files describing various products. Then the merchant builds a web page that is in the JITLA on-line mall and that enables a surfer or recipient to view a selected product file or web page in the on-line JITLA mall. Consequently, a surfer can reach a selected merchant web page by responding to a banner of the type illustrated in FIG. 14, or by going to the JITLA on line mall, conducting a search for a particular product, finding the merchant, finding a banner for a product offered by the merchant in which the surfer is interested, and by then accessing the appropriate web page on the product offered by the merchant.

After a surfer reviews a merchant web page and readies to leave the web page, the surfer must “grade and go” and click on a CSI grade number in the range of one to ten to leave the web site. As soon as the surfer grades the merchant's banner, he is exited from the web site and paid the agreed upon price for coming to the web site. When the surfer comes in to the merchant's web site, it is via a JITLA “ad-look” banner 210, 211 or other offer that surfer finds and accepts or clicks on to come to the merchant's web site.

If surfer's minimum ad-bid 198 (FIG. 14) is $1.50 and the merchant offered $1.00, the surfer will not even see the merchant's offer. The offer will not be shown on the surfer's JITLA QUEST CONTROLLER (FIG. 14). On the other hand, if the merchant offers $1.50 (and the desired discount set forth by the surfer) the merchant's “ad-look” or banner 210 will appear on the surfer's JITLA QUEST CONTROLLER and surfer can, if he or she likes the banner and CSI rating, click on the banner and goes to the merchant's web site. The surfer defines up front the minimum look and discount that the surfer will accept.

Consequently, the merchant is able to manipulate his advertising cost by varying the “look” amount and discount the merchant offers to pay and by varying the price of his product. However, merchant also is able to select up front desirable surfers or e-mail recipients by defining desired demographic data that a surfer or e-mail recipient should have. One of the demographic data a merchant can require is a certain “likelihood-to-buy” rating for a customer. JITLA monitors customer activities and calculates a likelihood to buy rating for a customer that is in the range of 1% to 100% and provides this rating to a merchant. If a customer does not have a sufficient likelihood to buy rating, then the merchant's banner (i.e., “ad-look” offer) is not sent to a prospective JITLA customer.

The data that a merchant initially inputs in the JITLA server 10 for a particular product includes the “ad-look” or “look” price the merchant will pay a surfer to look at the merchant's web site for a particular product, includes a discount the merchant is willing to offer. The data initially input by the merchant also includes ad-response parameters. Ad-response parameters define how much a merchant is willing to pay a surfer for each survey question that is at the merchant's web site and that is answered by a surfer before leaving the web site.

The ad-response is a tool the merchant can use to keep a surfer at a web site. The ad-response is a survey, but, importantly, it is a survey that pays a surfer for each question answered by the surfer. Each question can pay a surfer a different amount for answering the question. Some questions may be particularly valuable to a merchant, and the merchant will pay more to have the question answered.

The AIMS dashboard display 25 illustrated in FIGS. 2 to 12 is for real time operation and can be used to adjust real time “hot spots”. Hot spots that can be adjusted real time include the “ad-look” payment 202, 203 offered by a merchant, include the discount offered by the merchant, and include the product price offered by the merchant. Other data or components of a merchant's web page are altered by amending a “stand-by” off line web page and, after the desired amendments are made, by swapping that off-line amended web page for the current on-line web page. The off-line web page becomes the on-line web page in the JITLA on-line mall.

A surfer looking for a product at the JITLA on-line mall, can see ad-looks like those in FIG. 14, even if they offer less than the minimum ad-look (and discount) that the surfer inputs. If the surfer selects one of such ad-looks (or “looks”) and goes to a merchant's web site, the surfer is still paid (assuming the surfer carries out the required “grade and go” before the surfer leaves the web site.

To become a member of JITLA, a surfer and/or e-mail recipient inputs demographic information. There is no requirement on amount of information that a surfer must provide, but there is incentive to provide a reasonable amount of information because the buyer quality rating continuously calculated by the JITLA server (and provided to merchants) is in part a function of the demographic information provided (as well as a function of the buying habits of the surfer). JITLA tracks surfers in terms of where they have gone surfing and creates lists that are stored by the server in the surfer's STRONG BOX, where the STRONG BOX is simply a data storage file for the JITLA members (including surfers and e-mail recipients). The surfer (or e-mail recipient) decides what information in his or her STRONG BOX can be released by the JITLA surfer in the form of a calling card. The surfer (e-mail recipient) is free at any time to delete any of the demographic or other information that is in the surfer's STRONG BOX. This control by the surfer (e-mail recipient) of the surfer's demographic or other information is a key of the JITLA system. The demographic or other information that a surfer (or e-mail recipient) authorizes for release is offered to a merchant by the JITLA server in the form of a file termed a “calling card”. A merchant selects desired demographics and products that are associated with such demographics. If a surfer inputs information 194 (FIG. 14), this information, along with demographics defined by the merchant, is evaluated by the JITLA server. If the surfer demographics and desired price and buyer quality rating meet the criteria input by the merchant, then a banner or ad look 210 is sent to a surfer. If the surfer demographics, etc. don't meet the criteria of the merchant, a banner is not sent to the surfer. However, even if a banner is not sent to a surfer or e-mail recipient, the surfer might find, and click on, the banner by searching the on-line JITLA mall.

The merchant can, for example, require that the likelihood that a surfer will buy (i.e., the buyer quality rating) be 98%. In FIG. 11, in box 156 he enters buyer quality that he wants. In box 158, for a particular item offered for sale by the merchant, he enters the “ad-look” or “look” price he is willing to pay. Then in box 160 he puts in the total cumulative maximum amount he will pay for ad-response questions that a surfer can answer while at the merchant's web site for the product in question. In the DEMOGRAPHIC INTERESTS table in FIG. 11, the merchant can click on and off various demographic requirements under PROFILES. The SURFER TRAFFIC 170 indicates how many JITLA members are surfing and meet the merchant's demographic data requirements for a particular product at that given time, real time, that the merchant is viewing the AIMS dashboard display 25.

Buyer quality (or likelihood that a buyer will purchase) is a merchant “hot spot” in the sense that it constantly changes in real time. Buyer quality normally is not seen by surfer, and is only seen by the merchant.

FIG. 4 illustrates the number of current surfers that are looking for a particular product and that have a selected buyer quality rating. Consequently, about 20 people have a 10% likelihood of buying the product the merchant is selling; about 60 people have a 50% likelihood of buying the product the merchant is selling. The surfer traffic box 170 (FIG. 11) would, based upon the graph in FIG. 4, show the sum total of people that have a 50% or higher buyer quality rating (i.e. about 240 people).

A merchant utilizes the portion of the AIMS dashboard display 25 shown in FIG. 3 to direct his advertising to a specific web site. In box 26, the merchant can, for example, enter in the “TARGET IN” 26 display box www.walmart.com so that when a JITLA surfer is looking for a product like the merchant's at the Walmart web site, the merchant's ad-looks (i.e., banners) can appear on the surfer's computer screen along with information from Walmart on the same product. And, in the “CATEGORY” display box the merchant can enter www.walmart.com/TV so that the merchant's banner for TVs will appear on the surfer's computer display screen when the surfer is looking at the Walmart web site for televisions.

FIG. 5 in areas 46 and 47 provides a merchant with information that shows the ratio of sale made to number of looks by potential buyers (i.e., by surfers, e-mail recipient, and surfers going directly to the on-line mall).

FIG. 6 is utilized to modify the off-line stand by web site before it is swapped with and replaces the current on-line web site for a particular product. After the off-line web site is modifies, the merchant clicks “GO LIVE” 55 to swap the amended off-line site with the current on-line web site.

FIG. 9 is used by a merchant to enter date to modify “hot spots” real time, including the “LOOK” 110, 113 payment offered by a merchant, the “DISCOUNT” 115 116 offered by a merchant, and the product “PRICE” 119, 120 offered by a merchant.

FIG. 7 provides for a merchant an overview of sales. Display box 67 shows the number of sales per hour (per day, per minute, etc.). Display box 75 indicates that a merchant spend $50.00 to make five sale. Display box 76 indicates that a merchant paid $5.00 each for about twelve “looks” by surfers.

FIG. 8 is used along with FIGS. 7 and 5 to evaluate sales cost. Box 84 indicates ad volume for a particular product (web page) in terms of number of time per hour that the web page was viewed. Box 91 indicates the cost per hour for ads viewed. Box 97 indicates the total ad cost over an hour. Box 98 indicates the total discount cost per hour for the ad views in an hour.

A product and product reference number can be input in FIG. 12. Clicking on the BP 177 or KR 178 button provides graphs showing the cost to a merchant for a look by a surfer and showing the cost to a merchant for a look along with the discount offered in the look. These graphs show a merchant how he is spending money, show when costs in making a sale, and show a merchant whether he is making money.

FIG. 13 provides a comparison of one JITLA advertiser with another. If there are two merchants selling the same product and requiring the same surfer demographic information, FIG. 13 compares the “Look” cost and other selected criteria for each JITLA advertiser.

FIG. 10 shows the total portfolio advertising budget 142 for a person that in charge of selling particular products in a “portfolio” on a merchant's web site. If $10,000 in advertising is allocated for a day for the products in that portfolio, then as the $10,000 is spent, the amount remaining in the portfolio is reflected real time in display 142. This again helps a merchant see how he is spending his money.

JITLA provides merchants with real time feedback to evaluate how the merchant's marketing dollars are performing.

As used herein a merchant is an individual or entity that has something to offer a surfer or e-mail recipient.

In another embodiment of the invention, surfers or e-mail recipients can authorize the JITLA server to put their calling cards in the JITLA mall so the calling cards can be searched by other JITLA members looking for particular products or services or other items. At the same time, when a JITLA member (surfer or e-mail recipient) puts their calling card in the JITLA mall, the member can restrict who can look at the calling card so that the JITLA server 10 will not allow selected parties to view the calling card.

In another embodiment, a first JITLA member can put his calling card in the JITLA mall noting that the first JITLA member will not respond to a question by a second JITLA member unless the second JITLA member agrees to pay the first JITLA member (with the calling card) a certain price that is set forth on the calling card.

Having described my invention in such terms to enable those of skill in the art to understand and practice it, and having described presently preferred embodiments thereof, I claim:

1. A system to market products in an Internet network, including
(a) a computer server (10);
(b) a surfer computer (19);
(c) a surfer account;
(d) a merchant computer (21);
(e) a merchant account;
(f) a merchant web site;
said server (10) paying said surfer account a selected amount from said merchant account when said merchant web site is accessed by said surfer computer via the Internet network.
